(19) United States
(12) Patent Application Publication
(10) Pub. No.: US 2025/0260977 A1
(43) Pub. Date: Aug. 14, 2025

(54) Access Point Association

(71) Applicant: Comcast Cable Communications, LLC, Philadelphia, PA (US)

(72) Inventors: Rong Chen, Sunnyvale, CA (US); Allen Huotari, Garden Grove, CA (US)

(21) Appl. No.: 18/441,154

(22) Filed: Feb. 14, 2024

(51) Int. Cl. H04W 12/06; H04L 43/0882; H04W 60/04

(52) U.S. Cl. CPC H04W 12/06; H04L 43/0882; H04W 60/04

(57) ABSTRACT

A remote computing device may communicate with access points in a wireless network. Access points may receive instructions from a remote computing device to provide information to a mobile station. A mobile station may decide to stay with an access point or switch to a different access point based on the information.

### BACKGROUND

Wireless network access points (e.g., a Wi-Fi hot spot) may provide connectivity to various mobile stations (e.g., cell phones, laptops, etc.), but the access point may become overloaded at times.

### SUMMARY

The following summary presents a simplified summary of certain features. The summary is not an extensive overview and is not intended to identify key or critical elements.

Systems, apparatuses, and methods are described for recommending a station to connect to a different access point in a wireless network. A station may seek to use an access point for network access. For example, based on network capacity or conditions, the access point and/or a remote computing device may determine whether to allow the station to connect to the access point or recommend that the station connects to a different access point. After the determination, the access point may send, to the station, information instructing the station to connect to the access point, refrain from connecting to the access point, or find a different access point (e.g., a recommended access point or any other access point). Additionally, the information may contain at least one reason why connecting to the access point or a different access point (e.g., a recommended access point or any other access point) may be advisable. By using the information, the station may select to stay with the access point or connect to a different access point. The information may be contained in an association response, which may occur after the station has been successfully authenticated with the access point, and after the station has sent an association request.

These and other features and advantages are described in greater detail below.

### BRIEF DESCRIPTION OF THE DRAWINGS

Some features are shown by way of example, and not by limitation, in the accompanying drawings In the drawings, like numerals reference similar elements.

FIG. 1 shows an example communication network.

FIG. 2 shows hardware elements of a computing device.

FIG. 3A shows an example for a wireless network.

FIG. 3B shows an example for a wireless network.

FIG. 4 shows an example protocol for a station, access points, and a remote computing device.

FIG. 5A shows an example of fields of data in an association request.

FIG. 5B shows an example of fields of data in an association response.

FIG. 6 shows an example protocol for a station and access points.

FIG. 7 shows an example protocol for a station and access points.

FIG. 8 shows an example protocol for a station and access points.

FIG. 9 shows an example method for a remote computing device.

FIG. 10A shows an example method for an access point.

FIG. 10B shows an example method for an access point.

FIG. 11 shows an example method for a station.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

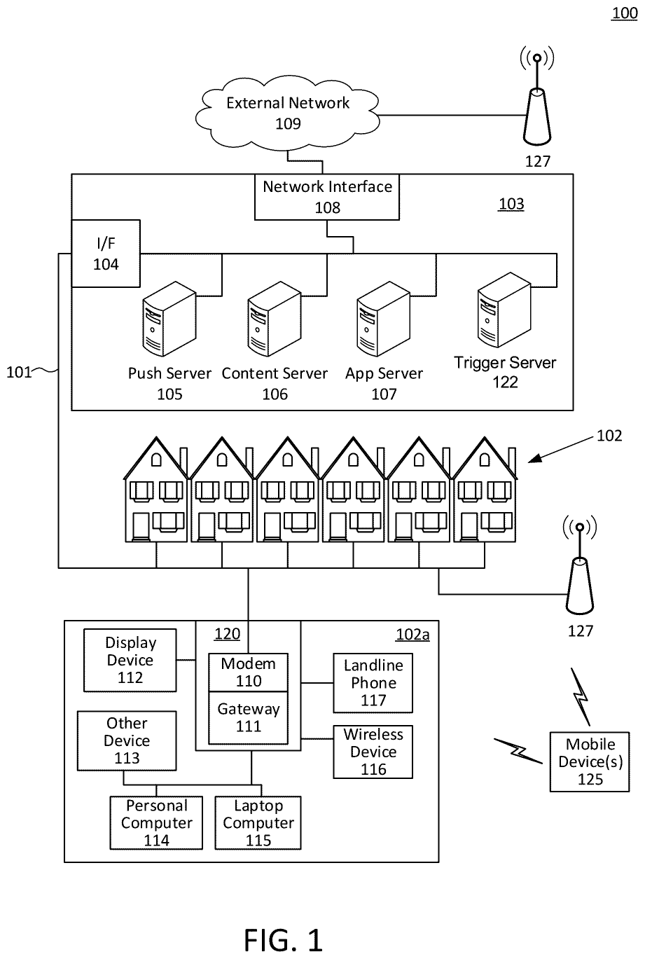

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the trigger server 122 (described below), additional push, content, and/or application servers, and/or other types of servers. Although shown separately, the push server 105, the content server 106, the application server 107, the trigger server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

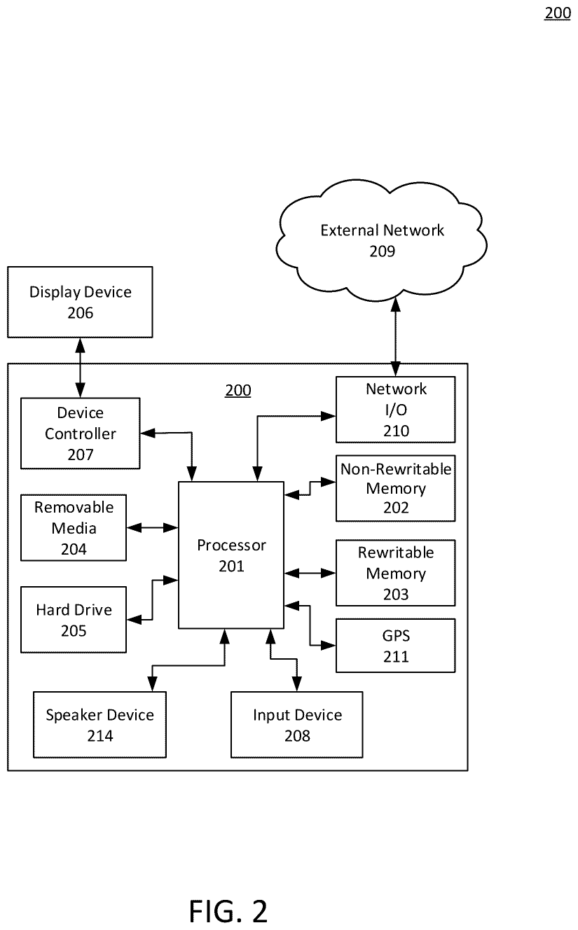

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

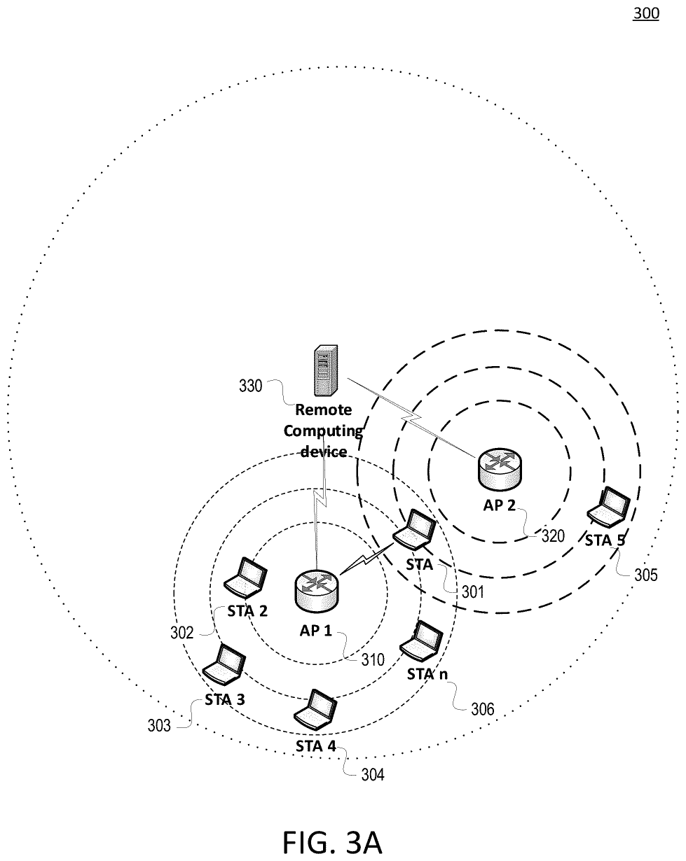

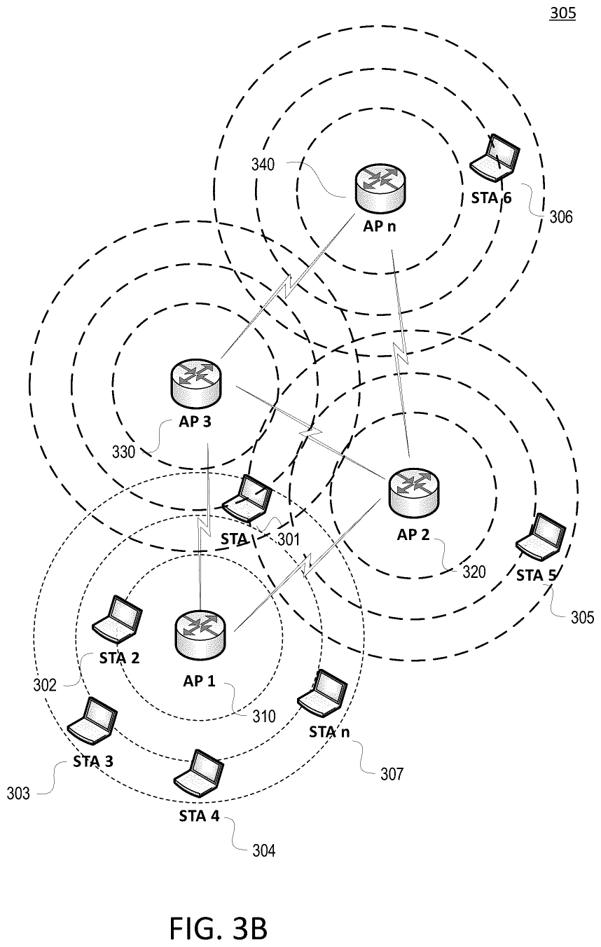

FIG. 3A shows an example for a wireless network. For example, the wireless network may be defined in accordance with the IEEE 802.11 standard. The wireless network may comprise a wireless local area network (WLAN) and/or a wireless mesh network. The wireless network may optionally include a remote computing device (e.g., central controller/coordinator), for example, to manage and/or optimize wireless network operations. The remote device may provide a centralized intelligence that may enhance the overall efficiency and/or manageability of the wireless network. The presence of the remote computing device (e.g., central controller/coordinator) may depend on the specific design and requirements of the wireless network deployment.

As described with respect to FIG. 3A, for example, the wireless network may optionally include a remote computing device 330 that may control (or coordinate) a plurality of APs on a plurality of bands/frequencies. For example, access points (APs) (e.g., an AP 1 310 and/or an AP 2 320) may be controlled by the remote computing device 330. A station (STA) (e.g., a STA 301, a STA 2 302, a STA3 303, . . . , and/or a STA n 306, which may be a mobile station computing device, such as a cell phone, portable computing device, laptop computer, or any other type of computing device that communicates wirelessly) may attempt to connect to an AP (e.g., the AP 1 301 or the AP 2 302), for example, to access a broader network, communicate wirelessly with other STAs, and/or access specific services provided by the wireless network. The remote computing device 330 may be able to gather the load of at least one AP in the wireless network, for example, because the AP may send its load information to the remote computing device 330. For example, based on network capacity or conditions (e.g., the load of at least one AP), the remote computing device 330 may determine whether to allow the STA to connect to the AP or recommend that the STA connects to a different AP.

For example, upon the determination, the AP may inform the STA to connect to the current AP (e.g., the AP itself), refrain from connecting to the current AP (e.g., the AP itself), or to seek a different AP (e.g., a recommended AP or any other AP). Additionally, the AP may provide the STA with at least one reason why connecting to the current AP (e.g., the AP itself) or a different AP (e.g., a recommended AP or any other AP) is advisable. For example, using the reason, the STA may accept or reject the AP's recommendation. Furthermore, as described below, the AP may allow the STA to connect to the AP itself but also with a recommend a different AP.

FIG. 3B shows another example for a wireless network. The wireless network may comprise a wireless mesh network. For example, the wireless mesh network may operate in a decentralized manner, where each of access points may be able to manage and/or optimize wireless network operations without a remote computing device (e.g., a central controller/coordinator). For example, APs (e.g., an AP 1 310, an AP 2 320, an AP 3 330, . . . , and/or an AP n 340) in the mesh wireless network may be able to establish mesh links and/or contribute to the self-organizing nature of the wireless network. In the wireless mesh network, the APs (e.g., an AP 1 310, an AP 2 320, an AP 3 330, . . . , and/or an AP n 340) may exchange information with each other through a plurality of methods. For example, The APs may periodically exchange route information and/or the presence of neighboring APs to comprehend the state of the mesh network. Communication among APs in a mesh network may adhere to specific protocols and/or mesh standards. For example, IEEE 802.11s is a standard designed for wireless mesh network, facilitating communication between the APs. APs in a mesh network may forward data to relay information among the APs.

An AP may be able to determine the load of at least one neighboring AP through a plurality of mechanisms. For example, an AP may periodically broadcast beacon messages containing information about the network (e.g., the AP's load). Neighboring APs may capture the beacon messages to gather information about the AP's load. Additionally or alternatively, an AP may send, to neighboring APs, probe requests containing information about the AP's current load and/or capacity. APs may exchange information on channel utilization, interference, and/or load to optimize channel allocation in the network. Furthermore, APs may exchange control messages designed specifically for load balancing, where the control messages may comprise information about traffic volume and/or any other relevant load metrics. Mesh networks may use neighbor discovery protocols, allowing APs to share information about the APs' presence, capabilities, and/or load with neighboring APs. In some mesh networks, a remote computing device (e.g., a centralized controller) may collect load information from all APs and/or make decisions based on the overall network load. The plurality of mechanisms described herein may depend of the specific implementation and/or protocols used in the mesh network. These mechanisms may enable APs to have awareness of neighboring loads, assist with load balancing, and/or optimize overall network performance.

As described with respect to FIG. 3B, for example, APs (e.g., an AP 1 310, an AP 2 320, an AP 3 330, . . . , and/or an AP n 340) in a mesh wireless network may communicate with one another. A STA (e.g., a STA 301, a STA 2 302, a STA3 303, . . . , and/or a STA n 307, which may be a mobile station computing device, such as a cell phone, portable computing device, laptop computer, or any other type of computing device that communicates wirelessly) may attempt to connect to an AP (e.g., the AP 1 310, the AP 2 320, the AP 3 330, . . . , or the AP n 340), for example, to access a broader network, communicate wirelessly with other STAs, and/or access specific services provided by the wireless network. For example, based on network capacity or conditions (e.g., the load of the AP and/or the load of neighboring APs), the AP (e.g., the AP 1 301, the AP 2 302, the AP 3 330, . . . , and/or the AP n 340) may determine whether to allow the STA to connect to the current AP (e.g., the AP itself) or recommend that the STA connects to a different AP. For example, upon the determination, the AP may inform the STA to connect to the current AP (e.g., the AP itself), refrain from connecting to the current AP (e.g., the AP itself), or to seek a different AP (e.g., a recommended AP or any other AP). Additionally, the AP may provide the STA with at least one reason why connecting to the current AP (e.g., the AP itself) or a different AP (e.g., a recommended AP or any other AP) is advisable. For example, using the reason, the STA may accept or reject the AP's recommendation. Furthermore, as described below, the AP may allow the STA to connect to the AP itself but also with a recommend a different AP.

In at least some wireless communications, a STA (e.g., active scanning STA) may send a probe request message to an AP to join the AP's network. For example, an active scanning STA actively send one or more probe request messages to discover available networks. The probe request message may comprise a specific AP's SSID for targeted communications or, without an SSID, serve as a general broadcast reaching all APs in the vicinity. Active scanning may prompt immediate response from APs. In environments with many networks (e.g., urban or densely populated areas), active scanning may help a STA more rapidly identify the best available network.

Additionally or alternatively, a STA (e.g., passive scanning STA) may passively listen for messages (e.g., beacon messages) broadcast by APs at regular intervals (e.g., typically every 100 ms) to detect available wireless networks, which is a less aggressive method of discovering networks. Passive scanning may be more power-efficient and/or may require less active transmission from the STA. Passive scanning may be useful when battery conservation is important and/or when the STA does not need to connect to a network as quickly as possible.

Furthermore, a STA may support both active and passive scanning methods for network discovery. For example, the selection between active and passive scanning may depend on the specific implementation and setting of the STA and/or the requirements of the network environment.

In at least some wireless communications, an AP may reject a STA's attempt to connect to the AP's network, for example, before association with the AP, by not responding to a probe request message from the STA. For example, if an AP decides to reject a STA to connect to the AP's network, the AP refrains from sending a probe respond message to the STA. However, if the STA does not receive a probe response message from the AP, the STA may assume that the probe request message or the probe response message may be lost, for example, due to interference. Consequently, the STA may repeat sending the probe request message for multiple times. This repetition may lead to unnecessary extra traffic congestion in the network and/or cause delayed connection for the STA.

Additionally, some probe response messages may contain reduced neighbor reports (RNR) of 6 GHZ APs. If the STA does not receive a probe response message containing information about 6 GHz APs from the AP, the STA's ability to discover 6 GHz APs may be jeopardized.

Furthermore, the method of an AP not sending a probe response message to reject a STA (e.g., active scanning STA) may not be effective against some STAs (e.g., passive scanning STAs), which do not anticipate receiving the probe response message in their connection process. For example, even though the AP refrains from sending a probe response message in order to reject the STA (e.g., active scanning STA), some STAs (e.g., passive scanning STAs) may attempt to connect to the AP because some STAs (e.g., passive scanning STAs) are not configured to expect to receive the probe response message from the AP and directly proceed to the initial phase (e.g., send an authentication request message to the AP).

Additionally or alternatively, a STA (e.g., a passive scanning STA) may send an authentication request message to an AP to join the AP's network, for example, because the STA (e.g., a passive scanning STA) may not be designed to send a probe request message. Similarly, if the AP does not intend to allow the STA to connect to the AP's network, the AP withholds sending an authentication respond to the STA. However, if the STA does not receive an authentication response from the AP, the STA may assume that the probe request or the probe response may be lost, for example, due to interference. Consequently, the STA may repeat sending the authentication request for multiple times. This repetition may lead to unnecessary extra traffic congestion in the network and/or cause delayed connection for the STA.

Some APs may respond to a STA's probe request message and allow the STA to proceed to the authentication phase, and then select to reject the STA by refraining from sending an authentication response message to the STA. This method may be used for both active scanning STAs and passive scanning STAs. However, if the STA (e.g., either active or passive scanning STA) does not receive the authentication response message from the AP, the STA (e.g., either active or passive scanning STA) may assume that either the authentication request message or the authentication response has been lost, for example, due to interference. Consequently, the STA (e.g., either active or passive scanning STA) may be uncertain about where to connect and/or may retry sending the authentication request message multiple times to the AP. This repetition may lead to unnecessary additional traffic congestion in the network and/or cause connection delays for the STA.

As described herein, upon receiving a probe request message from a STA, an AP may determine that the type of the STA is an active scanning STA, which sends a probe request message to actively search for wireless networks to connect to. Based on the type of the STA (e.g., active scanning STA) and the AP's ability (or capability) to service the STA, the AP may decide either to refrain from sending a probe response message or to send a probe response message with the intent of sending the STA information in the association phase. The information may comprise whether to allow or reject the STA, a recommended AP, and/or the reason for the recommendation.

Sending the information (e.g., whether to allow or reject the STA, a recommended AP, and/or the reason for the recommendation) via the probe response message may cause confusion and/or inefficiency. In Wi-Fi networking, a probe response message may be typically designed to convey basic network information (e.g., AP's SSID, etc.). Including the additional information during the initial scanning phase (e.g., probe phase) may overwhelm the STA. The STA may have to process and evaluate more data than necessary, potentially resulting in inefficiency and delay in network selection and connection. Additionally, the STA may keep sending the probe request messages, for example, if the STA does not receive the probe response message. Furthermore, if every AP includes the additional information (e.g., whether to allow or reject the STA, a recommended AP, and/or the reason for the recommendation) in probe response messages, it may lead to increased network traffic and congestion, particularly in areas with many networks (e.g., urban or densely populated regions). Additionally, sending too much information in a probe response message, which may not be encrypted, may pose security risks. Moreover, some STAs (e.g., passive scanning STAs), which are not configured to expect probe request messages, are consequently deprived of the opportunity to receive the information (e.g., whether to allow or reject the STA, a recommended AP, and/or the reason for the recommendation).

If the AP receives an authentication request message without previously receiving a probe request message from the STA, the AP may determine that the type of the STA is a passive scanning STA. Based on the type of the STA (e.g., passive scanning STA) and the AP's ability (or capability) to service the STA, the AP may decide either to refrain from sending an authentication response message or to send an authentication response message with the intent of sending the STA information in the association phase. The information may comprise whether to allow or reject the STA, a recommended AP, and/or the reason for the recommendation.

Sending the information (e.g., whether to allow or reject the STA, a recommended AP, and/or the reason for the recommendation) via the authentication response message may cause unnecessary confusion or misinterpretation. For example, if the STA receives the information (e.g., rejection) via the authentication response message from an AP, the STA may mistakenly assume there are problems with its credentials or the authentication process, causing repeated attempts or uncertainty about its access rights. Additionally, even if the AP refrains from sending the authentication response message in order to reject the STA, the STA may assume that either the authentication request message or the authentication response has been lost, for example, due to interference. Consequently, the STA may be uncertain about where to connect and/or may retry sending the authentication request message multiple times to the AP. This repetition may lead to unnecessary additional traffic congestion in the network and/or cause connection delays for the STA.

As described herein, information (e.g., whether to allow or reject the STA, a recommended AP, and/or the reason for the recommendation) may be sent via an association response message. Upon being authenticated (e.g., receiving an authentication response message), the STA may send an association request message to connect to the AP's network. The AP may then decide whether to allow or reject the STA, for example, based on network capacity, device compatibility, etc. During the association phase, both the STA and the AP may have sufficient information. For example, the STA knows it may authenticate, and the AP recognizes the STA may potentially join. If the AP needs to reject the STA (e.g., due to capacity issues), this association phase is the logical time to do so. The rejection may be more specific and informative, as both the STA and the AP may have already established basic compatibility.

Even if an AP does not intend to allow a STA to connect to the AP's network, the AP may send a probe response message (or an authentication response message) to the STA upon receiving a probe request message (or an authentication request message) from the STA. This approach aims, for example, to prevent the STA from repeatedly sending the probe request message multiple times, which may cause unnecessary extra traffic congestion and/or delay the STA's connection.

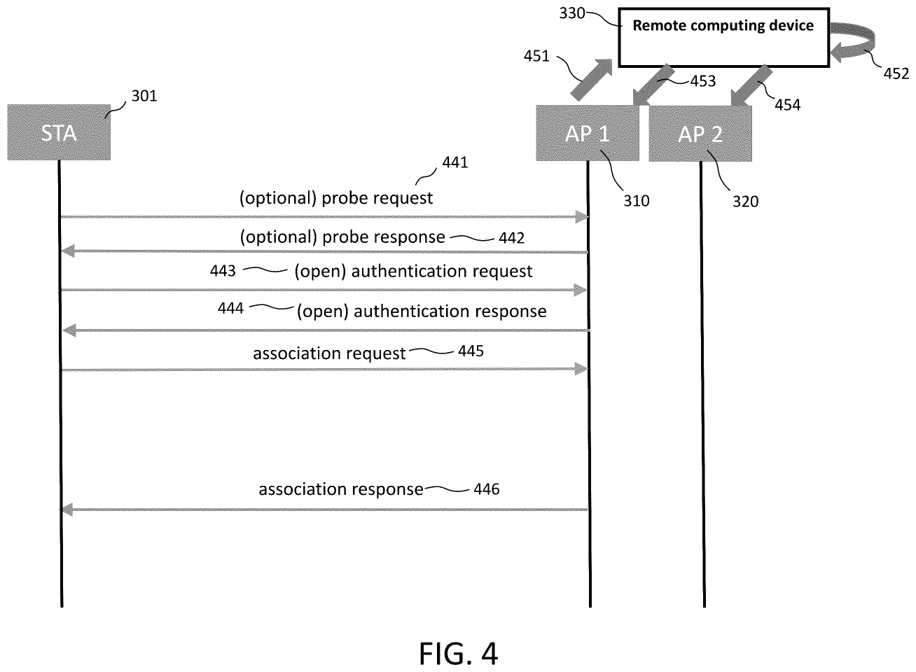

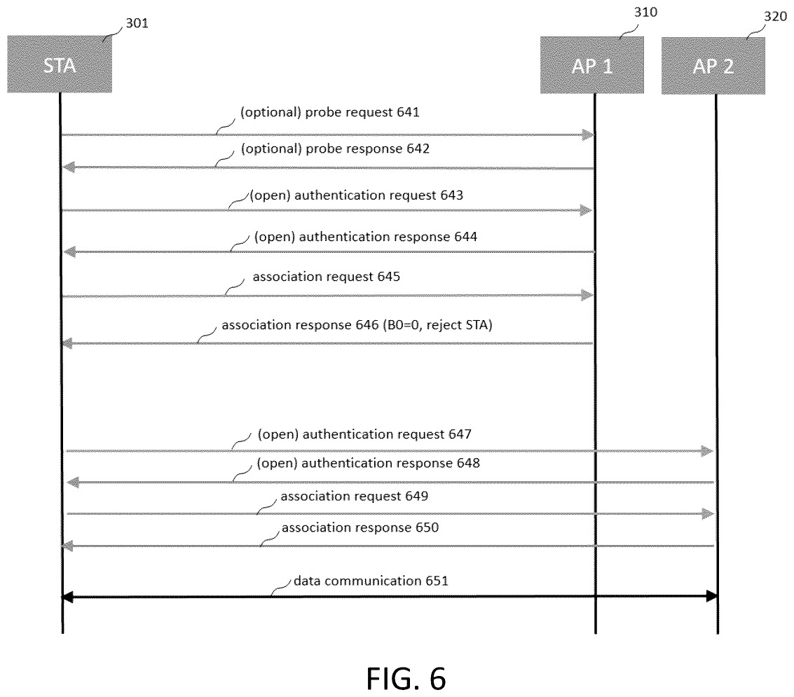

FIG. 4 shows an example protocol for a station, access points, and a remote computing device. The STA 301 may optionally send a probe request 441 to an AP 1 310. For example, a probe request defined in the IEEE 802.11 standard may be a management frame used by a Wi-Fi station to discover and/or identify available wireless networks in its proximity. Based on receiving the probe request 441 from the STA 301 (which indicates the STA 301 is an active device), the AP 1 301 may determine whether to allow the STA 301 to connect to the AP 1 301 or to recommend that the STA 301 connects to a different AP. Based on the determination, the AP 1 301 sends a probe response 442 to the STA 301 (which indicates the intent of sending the STA 301 an association response). The STA 301 may send an authentication request 443 to the AP 1 310. Based on receiving the authentication request 443 from the STA 301, the AP 1 310 sends an authentication response 444 to the STA 301. The STA 301 may send an association request 445 to the AP 1 310. For example, in accordance with the IEEE 802.11 standard, an association request is a management frame used by a Wi-Fi station to request permission to join a specific wireless network. As described herein, for example, the association request 445 may contain one or more fields requesting additional information in an association response 446 (as described in greater detail in FIG. 6A and FIG. 6B). Based on receiving the association request 445 from the STA 301, the AP 1 310 may send, to the remote computing device 330, information of the association request 445 (e.g., a step 451 in FIG. 4). Based on receiving the information of the association request 445 from the AP 1 310, the remote computing device 330 may determine whether the STA 301 should connect to the AP 1 310 or connect to a recommended/different AP (e.g., an AP 2 320), for example, based on a network condition and/or an internal policy of the remote computing device 330 (e.g., a step 452). The remote computing device 330 may inform the AP 1 310 to include a status code in an association response 446 (e.g., a step 453). The status code may indicate success (e.g., status code 0) if the remote computing device 330 may determine that the STA 301 should connect to the AP 1 310.

Based on receiving the one or more fields in the association request 445, the remote computing device 330 may determine the values of fields in the association response 446 (as described in greater detail in FIG. 6A and FIG. 6B). For example, in accordance with the IEEE 802.11 standard, an association response is a management frame that may be sent by an AP based on an association request from a STA. An association response may serve to either accept or reject the STA's request to join the network and/or may include essential network configuration parameters.

As described herein, an association response may contain information (e.g., status code) comprising a Basic Service Set Identifier (BSSID), a band, a channel, an operating class, and/or any other details about a different recommended access point. Additionally or alternatively, an association response may contain information (e.g., status code) indicating redirection of a STA to a different recommended access point. An association response may contain information (e.g., status code) indicating redirection of a STA to a different recommended band and/or channel. An association response may contain information (e.g., status code) indicating rejection of a STA even if the access point that the STA attempts to connect to is not busy. This rejection may be the purpose of redirecting the STA.

The remote computing device 330 may inform the AP 2 320 to accept the STA 301, if the remote computing device 330 may determine that the STA 301 should connect to the AP 2 320. The AP 1 310 may send the association response 446 containing the status code and/or the values of fields determined by the remote computing device 330.

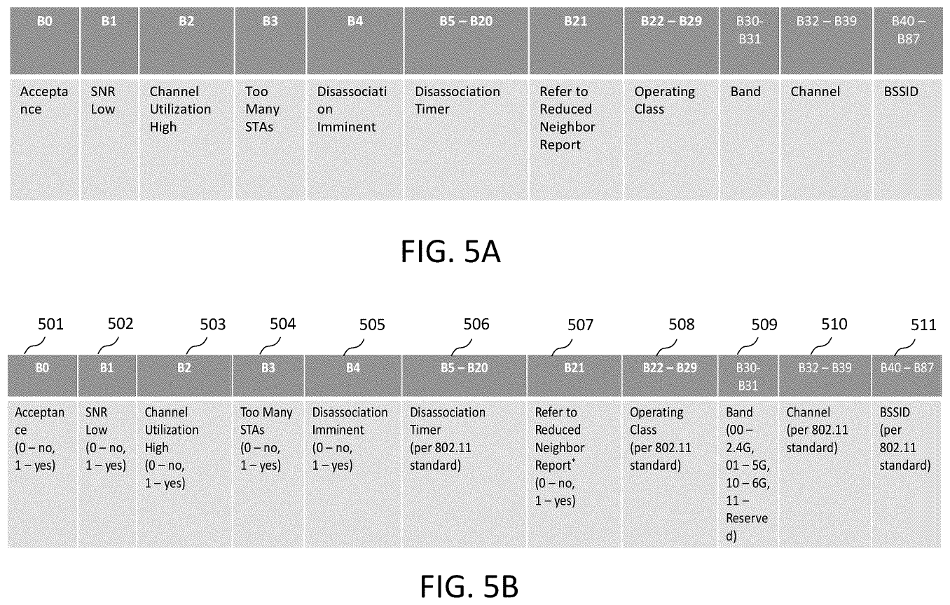

FIG. 5A shows an example of fields of data in an association request. As described herein, the association request may contain one or more fields of data comprising information that a STA may expect to receive in an association response. For example, as shown in FIG. 5A, the association request may contain fields (e.g., B0-B47). Initially, the values of the fields (e.g., B0-B47) may be set to null. The association response from an access point may contain the values of the fields (e.g., B0-B47). Additional fields providing extra information (not shown in FIG. 5A) may be contained in the association request.

FIG. 5B shows an example of fields of data in an association response. As described herein, the association response may contain one or more fields of data comprising information requested in an association request. For example, the one or more fields of data may comprise at least one reason to reject the STA, information about a different recommended access point, and/or any other information. As shown in FIG. 5B, for example, a field B0 501 may indicate whether the STA may be permitted to connect to an access point that the STA attempts to connect to. The STA may connect to the access point, for example, if the field B0 indicates success (e.g., B0=1). The STA may not be permitted to connect to the AP, for example, if the field B0 indicates fail (e.g., B0=0). At least some fields such as B1 to B3 of the fields in the association response may indicate at least one reason to reject the STA. For example, a field B1 502 may indicate whether a signal quality/strength (e.g., a signal-to-noise ratio (SNR) in downlink communication channel or an SNR in uplink communication channel) associated with the STA is low (e.g., B1=1). A field B2 503 may indicate whether channel utilization associated with the AP is high (e.g., B2=1). A field B3 504 may indicate whether too many STAs are connected to the AP (e.g., B3=1).

At least some fields such as B4 to B20 may indicate disassociation between the STA and the AP. For example, a field B4 505 may indicate that the STA may be disassociated from the AP after a period of time (e.g., B4=1). The filed B4 505 may be used, for example, if at least one condition (e.g., a low signal quality/strength, interference, and/or any other conditions) may affect the quality of the connection between the STA and the AP. Fields B5-B20 506 may indicate a grace period during which the STA may still communicate with the AP before the connection between the STA and the AP is terminated.

At least some fields such as B21 to B87 may indicate information about a different recommended access point (e.g., such as reduced neighbor report (RNR), an operating class, a band, a channel, a BSSID, and/or any other information of the different recommended AP). For example, a field B21 may indicate that the STA needs to refer to an RNR (e.g., B21=1). For example, the RNR may comprise information (e.g., a band, a channel, a BSSID, signal strength, etc.) associated with the different recommended access point. Fields B22-B29 may indicate an operating class associated with the different recommended access point. Fields B30-B31 may specify a frequency band associated with the different recommended access point (e.g., 00=2.4 GHz, 01=5 GHz, 10=6 GHZ, etc.). Fields B32-B39 may specify a channel associated with the different recommended access point. Fields B40-B87 may indicate a BSSID associated with the different recommended access point.

FIG. 6 shows an example protocol for a station and access points. As shown in FIG. 6, the STA 301 may optionally send a probe request 641 to an AP 1 310. Based on receiving the probe request 641, the AP 1 310 sends a probe response 642 to the STA 301. The STA 301 may send an authentication request 643 to the AP 1 310. Based on receiving the authentication request 643, the AP 1 310 sends an authentication response 644 to the STA 301. The STA 301 may send an association request 645 to the AP 1 310. The association request 645 may contain one or more fields requesting additional information in an association response 646. Based on receiving the association request 645, the AP 1 310 may send an association response 646 to the STA 301. The association response 646 may contain a status code indicating the STA 301 should connect to a different recommended AP (e.g., an AP 2 320 in FIG. 6). Based on receiving the one or more fields in the association request 645, the association response 646 may contain a field indicating that the AP 1 310 rejects the STA 301 (e.g., B0=0). The association response 646 may contain one or more fields indicating at least one reason to reject the STA 301 (e.g., B1-B3). The association response 646 may contain one or more fields (e.g., B21 to B87) indicating information about the different recommended AP 2 320 (e.g., such as a BSSID, a band, a channel, an operating class, and/or any other information of the AP 2 320).

Based on accepting the reason to reject (e.g., based on B1-B3 in the association response 646) and agreeing to connect to the different recommended AP 2 320 (e.g., based on B21 to B87 in the association response 646), the STA 301 may send an authentication request 647 to the different recommended AP 2 320 indicated by the association response 646. Based on receiving the authentication request 647, the AP 2 320 sends an authentication response 648. The STA 301 may send an association request 649 to the AP 2 320. Based on receiving the association request 649, the AP 2 320 may send an association response 650 to the STA 301. Based on receiving the association response 650 from the AP 2 320, the STA 301 may start data communication 651 with the AP 2 320. Optionally, the STA 301 and the AP 2 320 may perform an authentication (e.g., a 4-way handshake authentication, IEEE 802.1X authentication, etc.) before the data communication 651.

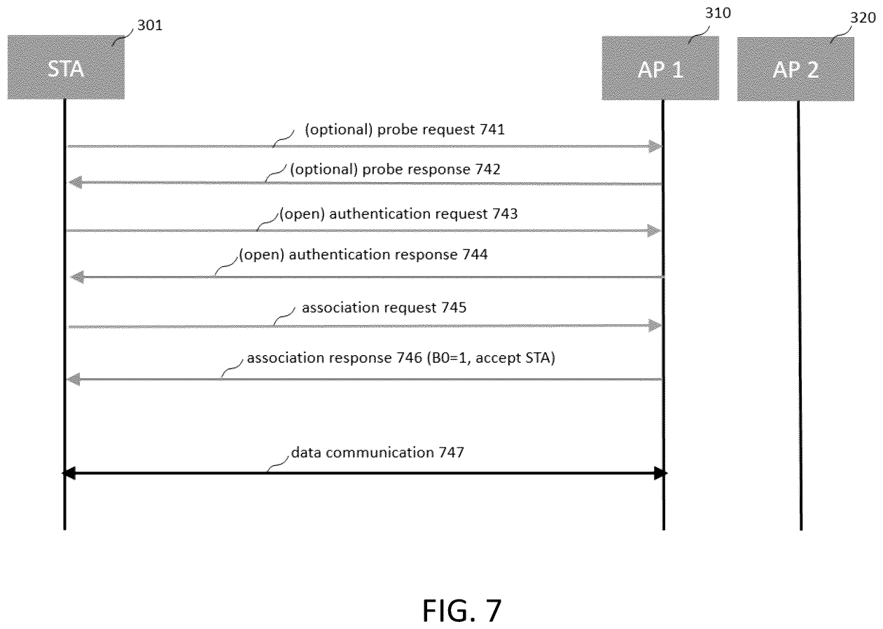

FIG. 7 shows an example protocol for a station and access points. As shown in FIG. 7, the STA 301 may optionally send a probe request 741 to an AP 1 310. Based on receiving the probe request 741, the AP 1 310 sends a probe response 742 to the STA 301. The STA 301 may send an authentication request 743 to the AP 1 310. Based on receiving the authentication request 743, the AP 1 310 sends an authentication response 744 to the STA 301. The STA 301 may send an association request 745 to the AP 1 310. The association request 745 may contain one or more fields requesting additional information in an association response 746. Based on receiving the association request, the AP 1 310 may send an association response 746 to the STA 301. Based on receiving the one or more fields in the association request 745, the association response 746 may contain a status code indicating the STA 301 should connect to a different recommended AP (e.g., an AP 2 320 in FIG. 7). As described herein, the association response 746 may contain information about a different recommended AP 2 320 (e.g., in B21 to B87 of the association response 746). However, as described herein, the AP 1 310 may give the STA 301 an option to stay with the AP 1 310 even though the AP 2 320 is recommended in the association response 746. For example, the association response 746 may contain a field indicating that the STA 301 may stay with the AP 1 310 (e.g., B0=1). Based on the association response 746, the STA 301 may select an option to stay with the AP 1 310 even though the AP 2 320 is recommended. The STA 301 may start data communication 747 with the AP 1 310 based on receiving the association response 746. Optionally, the STA 301 and the AP 1 310 may perform an authentication (e.g., a 4-way handshake authentication, IEEE 802.1X authentication, etc.) before the data communication 747.

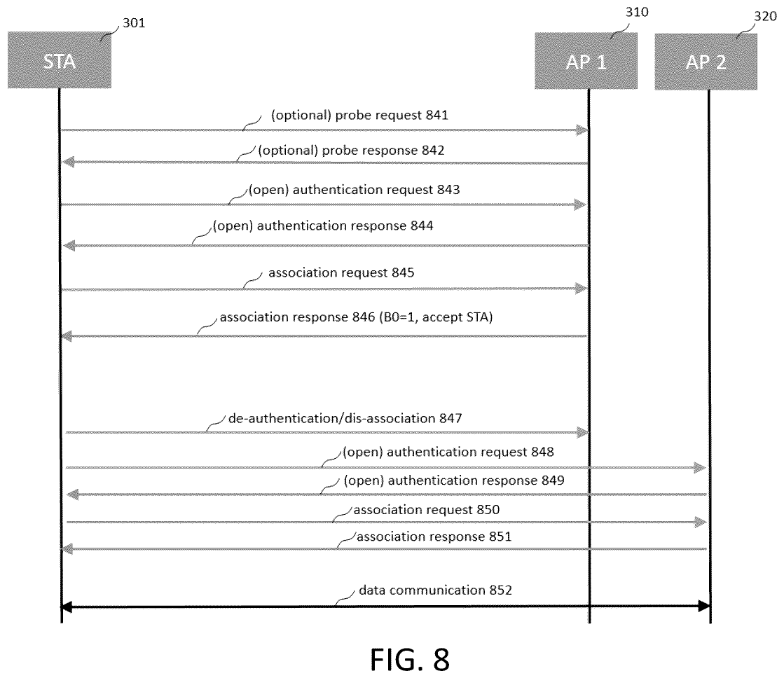

FIG. 8 shows an example protocol for a station and access points. As shown in FIG. 8, the STA 301 may optionally send a probe request 841 to an AP 1 310. Based on receiving the probe request 841, the AP 1 310 sends a probe response 842 to the STA 301. The STA 301 may send an authentication request 843 to the AP 1 310. Based on receiving the authentication request 843, the AP 1 310 sends an authentication response 844 to the STA 301. The STA 301 may send an association request 845 to the AP 1 310. The association request 845 may contain one or more fields requesting additional information in an association response 846. Based on receiving the association request 845, the AP 1 310 may send an association response 846 to the STA 301. The association response 846 may contain a status code indicating the STA 301 should connect to a different recommended AP (e.g., an AP 2 320 in FIG. 8). Based on receiving the one or more fields in the association request 845, the association response 846 may contain one or more fields indicating information about the different recommended AP 2 320 (e.g., in B21 to B87 fields). As described above, the AP 1 310 may give the STA 301 an option to stay with the AP 1 310 even though the AP 2 320 is recommended in the association response 846 (e.g., B21 to B87). For example, the association response 846 may contain a field indicating that the STA 301 may stay with the AP 1 310. However, even though the STA 301 has an option to stay with the AP 1 310, based on the association response 846, the STA 301 may select to connect to the different recommended AP 2 320. The STA 301 may send a de-authentication frame and/or a dis-association frame to the AP 1 310. The STA 301 may send an authentication request 848 to the AP 2 320. Based on receiving the authentication request 848, the AP 2 320 sends an authentication response 849. The STA 301 may send an association request 850 to the AP 2 320. Based on receiving the association request 850, the AP 2 320 sends an association response 851. The STA 301 may start data communication 852 with the AP 2 320 based on receiving the association response 851. Optionally, the STA 301 and the AP 1 310 may perform an authentication (e.g., a 4-way handshake authentication, IEEE 802.1X authentication, etc.) before the data communication 852.

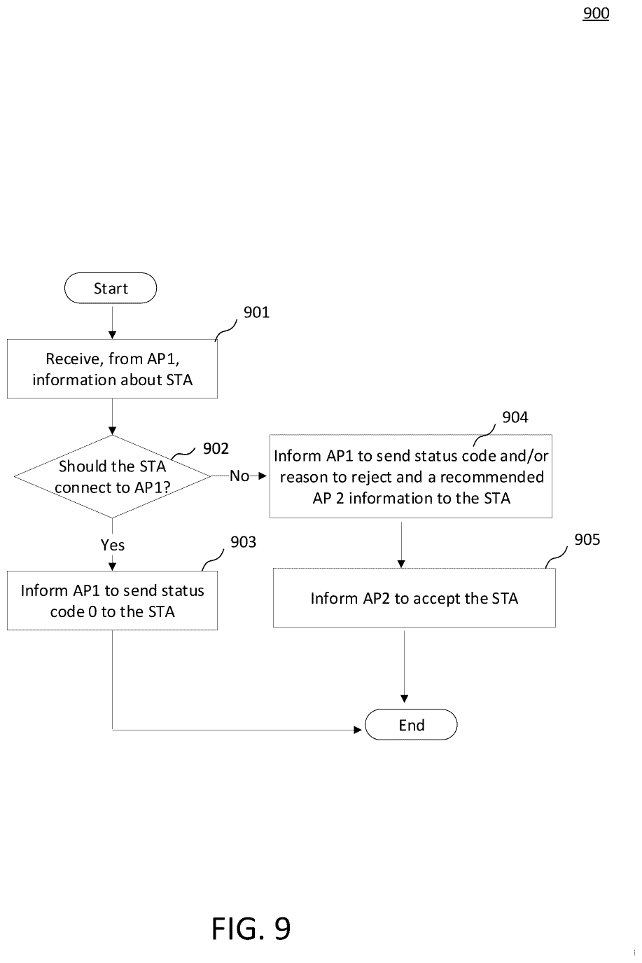

FIG. 9 shows an example method for a remote computing device. At step 901, a remote computing device (e.g., the remote computing device 330 in FIG. 4) may receive, from a first access point (e.g., an AP 1 310), information about a STA (e.g., a STA 301) such as an association request (e.g., step 451). At step 902, the remote computing device may determine whether the STA should connect to the first access point (e.g., step 452 in FIG. 4). For a “Yes” determination, step 903 may be implemented. For example, the remote computing device may inform the first access point to send a status code to the STA (e.g., step 453). The status code may indicate the STA may be permitted to connect to the first access point (e.g., status code 0). For a “No” determination, step 904 may be implemented. For example, the remote computing device may inform the first access point to send a status code and a reason to reject to the STA (e.g., step 453 in FIG. 4). The status code may indicate the STA should connect to a different access point. At step 905, the remote computing device may inform a second access point (e.g., an AP 2 320) to accept the STA (e.g., step 454 in FIG. 4).

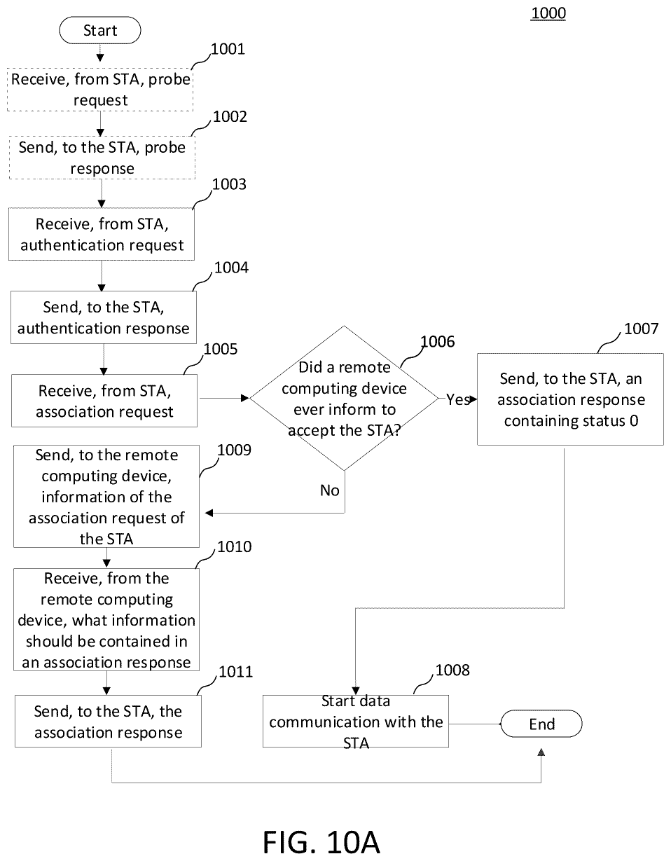

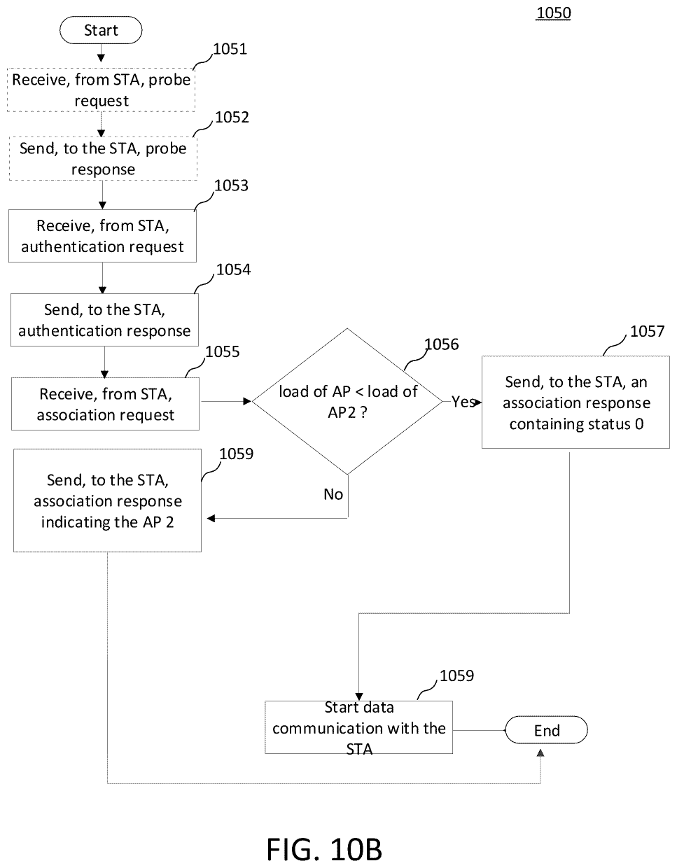

FIG. 10A shows an example method for an access point. At step 1001, optionally, an AP may receive, from a STA, a probe request. At step 1002, if the AP may have received the optional probe request, the AP may send, to the STA, a probe response. At step 1003, the AP may receive, from the STA, an authentication request. At step 1004, the AP may send, to the STA, an authentication response. At step 1005, the AP may receive, from the STA, an association request. At step 1006, the AP may determine whether a remote computing device has ever informed the AP to accept the STA. For a “Yes” determination, step 1007 may be implemented. For example, the AP may send, to the STA, an association response containing a status code. The status code may indicate the STA may be permitted to connect to the AP (e.g., status code 0). At step 1008, the AP may start data communication with the STA. For a “No” determination, step 1009 may be implemented. For example, the AP may send, to the remote computing device, information about the association request of the STA. At step 1010, the AP may receive, from the remote computing device, which information should be contained in the association response. At step 1011, the AP may send, to the STA, the association response.

FIG. 10B shows an example method for an access point. At step 1051, optionally, an AP may receive, from a STA, a probe request. At step 1052, if the AP may have received the optional probe request, the AP may send, to the STA, a probe response. At step 1053, the AP may receive, from the STA, an authentication request. At step 1054, the AP may send, to the STA, an authentication response. At step 1055, the AP may receive, from the STA, an association request. At step 1056, the AP may determine whether the load of the AP is lower than the load of a neighboring AP (e.g., an AP 2). For a “Yes” determination, step 1057 may be implemented. For example, the AP may send, to the STA, an association response containing a status code. The status code may indicate the STA may be permitted to connect to the AP (e.g., status code 0). For a “No” determination, step 1059 may be implemented. For example, the AP may send, to the STA, an association response indicating the AP 2.

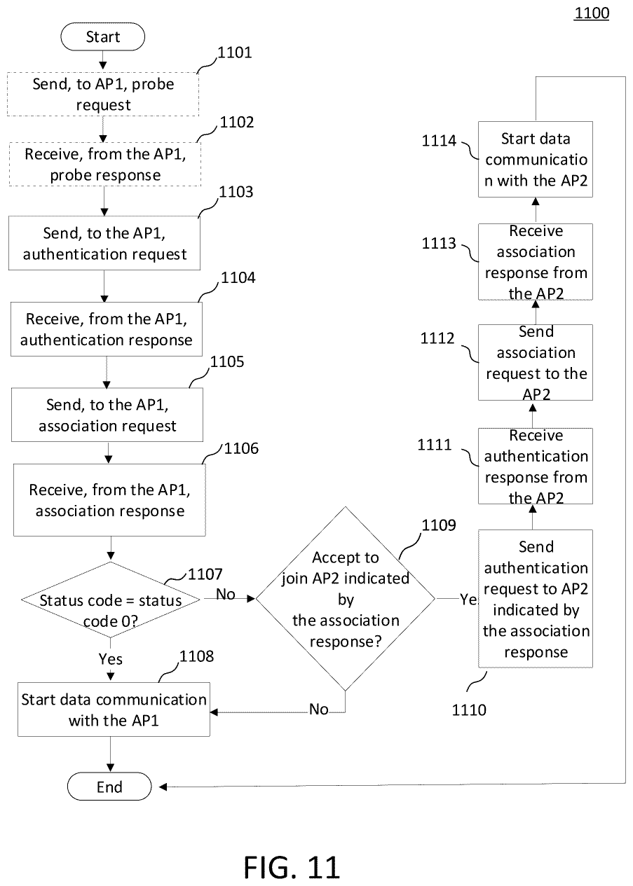

FIG. 11 shows an example method for a station. At step 1101, optionally, a STA may send, to a first access point, a probe request. At step 1102, if the STA may have optionally sent the probe request, the STA may receive, from the first access point, a probe response. At step 1103, the STA may send, to the first access point, an authentication request. At step 1104, the STA may receive, from the first access point, an authentication response. At step 1105, the STA may send, to the first access point, an association request. At step 1106, the STA may receive, from the first access point, an association response. For example, the association response defined in the IEEE 802.11 standard is a frame that may be sent by an access point (AP) based on an association request from a station (STA). The association response may serve to either accept or reject the STA's request to join the network and/or may include essential network configuration parameters. At step 1107, the STA may determine whether the association response may contain a status code indicating that the STA may be permitted to connect to the AP (e.g., status code 0). For a “Yes” determination, step 1108 may be implemented. For example, the STA may connect to the first access point. For a “No” determination, step 1109 may be implemented. For example, the STA may determine whether to join a second access point that the association response may indicate. The association response may contain a status code (e.g., status code described herein, status code 82, status code 99, or status code 17) and/or one or more fields of data that may indicate a reason to reject the STA. For a “No” determination, step 1108 may be implemented. For example, the STA may start data communication with the first access point. For a “Yes” determination, step 1110 may be implemented. For example, the STA may send an authentication request to a second access point. At step 1111, the STA may receive an authentication response from the second access point. At step 1112, the STA may send an association request to the second access point. At step 1113, the STA may receive an association response from the second access point. At step 1114, the STA may start data communication with the second access point.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method comprising:
receiving, by a wireless access point and from a mobile station, an authentication request to connect to a wireless network of the wireless access point;
sending, to the mobile station and based on the authentication request, an authentication response indicating successful authentication of the mobile station;
receiving, after sending the authentication response, an association request from the mobile station; and
sending, to the mobile station and based on the association request, an association response indicating that the mobile station should connect to a different wireless access point.

2. The method of claim 1, further comprising receiving, from a remote computing device, an instruction to send the association response indicating that the mobile station should connect to the different wireless access point.

3. The method of claim 1, wherein the association response comprises at least one field indicating at least one reason why the mobile station should connect to the different wireless access point.

4. The method of claim 1, further comprising determining a load of at least one other access point, based on information, wherein the at least one other access point broadcasts the information.

5. The method of claim 1, wherein the association response comprises a value associated with a received signal quality or channel utilization of the wireless access point.

6. The method of claim 1, wherein the association response comprises a value indicating that the wireless access point is currently associated with a high quantity of other mobile stations.

7. The method of claim 1, wherein the association response comprises information indicating a band, a channel, a basic service set identifier (BSSID), and an operating class of the different wireless access point.

8. The method of claim 1, wherein the association response comprises at least one field indicating whether the wireless access point accepts the mobile station.

9. The method of claim 1, where the association response comprises at least one field indicating a reduced neighbor report (RNR) associated with the different access point.

10. A method comprising:
sending, by a mobile station and to a wireless access point, an authentication request to connect to a wireless network of the wireless access point;
receiving, by the mobile station and from the wireless access point, the authentication response indicating successful authentication of the mobile station;
sending, after receiving the authentication response, an association request, to the wireless access point; and
receiving, by the mobile station and from the wireless access point, an association response indicating that the mobile station should connect to a different access point.

11. The method of claim 10, wherein the association response comprises at least one field indicating at least one reason why the mobile station should connect to the different wireless access point.

12. The method of claim 10, wherein the association response comprises a received signal quality associated with the wireless access point.

13. The method of claim 10, wherein the association response comprises a value indicating channel utilization associated with the wireless access point.

14. The method of claim 10, wherein the association response comprises a value indicating that the wireless access point is currently associated with a high quantity of other mobile stations.

15. The method of claim 10, wherein the association response comprises information indicating a band, a channel, a basic service set identifier (BSSID), and an operating class of the different wireless access point.

16. The method of claim 10, further comprising connecting to the wireless network of the wireless access point based on the association response comprising at least one field indicating at least one reason why the mobile station should connect to the different wireless access point.

17. The method of claim 10, further comprising connecting to the different wireless access point based on the association response comprising information indicating the different wireless access point.

18. A method comprising:
receiving, by a remote computing device and from a wireless access point, information indicating that the wireless access point has received, from a mobile station, as association request to connect to a wireless network of the wireless access point; and
sending, by the remote computing device and to the wireless access point, an instruction to send, by the wireless access point and to the mobile station, an association response.

19. The method of claim 18, further comprising informing a different wireless access point to accept the mobile station.

20. The method of claim 18, wherein the association response comprises an available capacity of a different wireless access point, and wherein the association response is based on a network capacity.
